(19) United States
(12) Patent Application Publication
(10) Pub. No.: US 2017/0071172 A1
(43) Pub. Date: Mar. 16, 2017

(54) Novel sump filtration system for aquarium tanks

(71) Applicant: David Derrick, San Jose, CA (US)

(72) Inventor: David Derrick, San Jose, CA (US)

(21) Appl. No.: 15/131,005

(22) Filed: Apr. 17, 2016

Related U.S. Application Data
(60) Provisional application No. 62/189,203, filed on Jul. 6, 2015.

(51) Int. Cl. A01K 63/04; A01K 63/00

(52) U.S. Cl. CPC A01K 63/045; A01K 63/006; A01K 63/047

(57) ABSTRACT

This disclosure pertains to aquarium systems, and in particular to a novel sump filtration systems for aquarium tanks. A sump filtration system consistent with the present disclosure comprises an enclosed compartment. The enclosed compartment comprises a plate holder that supports a plurality of filter configurations. Another sump filtration system includes a first wall and a second wall wherein the second wall opposes the first wall. The second wall may have a first media tray at a top portion and a second media tray at a bottom portion. The first wall is fixed to a surface and the second wall is moveable in a vertical direction.

### CROSS-REFERENCE TO RELATED APPLICATION

This application claims the benefit of U.S. Provisional Application No. 62/189,203 filed Jul. 6, 2015.

### FIELD

This disclosure pertains to aquarium systems, and in particular (but not exclusively) to a novel sump filtration system for aquarium tanks.

### BACKGROUND

Many aquarium systems with sump filtration units are implemented as overflow boxes that are located inside of or external to the display tanks. In these systems, aquarium water flows from the display tank to a sump unit by gravity or via a siphon means. As aquarium water flows through the sump filtration unit, the water is purified and chemically altered in a desired manner. For example, aquarium water may be oxygenated or infused with additives (e.g., calcium, magnesium, or alkali materials), sterilized, or mechanically filtered to purify the water by removing any particulates therein. After the aquarium water is purified, the water is routed back to the display tank.

Unfortunately, many sump filtration units are limited to a single configuration unit and can only purify or chemically alter aquarium water using a single technique. As such, a need exists for a sump filtration unit that can purify or chemically alter aquarium water by various techniques.

### SUMMARY OF THE DISCLOSURE

The present disclosure provides a novel sump filtration system (“sump unit”) for aquarium tanks. A sump filtration system consistent with the present disclosure may incorporate a silencing mechanism to reduce noise from water flow. The sump unit may incorporate any of various plate holders to support various filter-media types and accommodate various filtering configurations.

The present disclosure also provides for a self-adjusting media tray to adapt to various water levels as required by different auxiliary filters (e.g., protein skimmers). In addition, an interchangeable drain input plate may be incorporated to accommodate a plurality of bulkhead fittings for various aquarium designs that allow for compatibility with the fitting(s) of the display tank.

### BRIEF DESCRIPTION OF THE FIGURES

To facilitate understanding, identical reference numerals have been used, where possible, to designate identical elements that are common to the drawings. The drawings are not to scale and the relative dimensions of various elements in the drawings are depicted schematically and not necessarily to scale. The techniques of the present disclosure may be readily understood by considering the following detailed description in conjunction with the accompanying drawings, in which:

FIG. 1 is a partial illustration of a sump unit that allows for installation of various interchangeable filtration devices.

FIG. 2A is a partial illustration of a sump unit with a filter sock plate installed therein.

FIG. 2B is a partial illustration of a sump unit with a filter sock plate and filter sock installed therein.

FIG. 3A is a partial illustration of a sump unit with a perforated plate installed therein.

FIG. 3B is a partial illustration of a sump unit with a perforated plate and a foam block installed therein.

FIG. 4A is an exemplary illustration of a self-adjusting media tray apparatus.

FIG. 4B is an exemplary illustration of a self-adjusting media tray apparatus having a self-adjusting media tray in a second position within a sump unit.

FIG. 5A is another illustration of a self-adjusting media tray in a first position.

FIG. 5B depicts another illustration of the self-adjusting media tray in a second position.

FIG. 6 is yet another illustration of a sump unit which features a first filtering configuration.

FIG. 7 is a top view of the sump unit illustrated in FIG. 6.

FIG. 8 is an exemplary illustration of a sump unit which features a second filtering configuration.

FIG. 9 is another exemplary illustration of a sump unit which features a third filtering configuration.

FIG. 10 is an exemplary illustration of a sump unit which features a fourth filtering configuration.

FIG. 11 is an exemplary illustration of a sump unit which features a fifth filtering configuration.

FIG. 12 is an exemplary illustration of a sump unit which features a sixth filtering configuration.

FIG. 13 is a perspective illustration of a novel sump unit.

FIG. 14 is an illustration of a route that aquarium water travels through a sump system consistent with the present disclosure.

### DETAILED DESCRIPTION

A detailed description of some embodiments is provided below along with accompanying figures. The detailed description is provided in connection with such embodiments, but is not limited to any particular example. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments has not been described in detail to avoid unnecessarily obscuring the description.

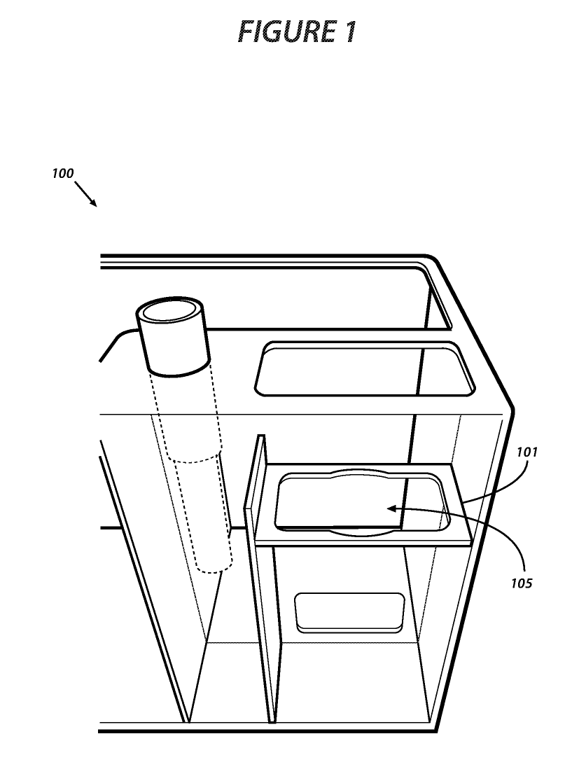

FIG. 1 is a partial illustration of a sump unit 100 that allows for installation of various interchangeable filtration devices. The present disclosure provides an advantage over traditional sump units by providing a means to configure various filtering mechanisms.

Filter plate holder 101 facilitates the installation of various filtering devices. For example, filter plate holder 101 has an opening 105 through which a filter sock can suspend there through. Alternatively, or additionally according to some embodiments, other filtering devices may be supported by filter plate holder 101. It should be understood by one having ordinary skill in the art that sump unit 100 may be incorporated within an aquarium system as will be described below.

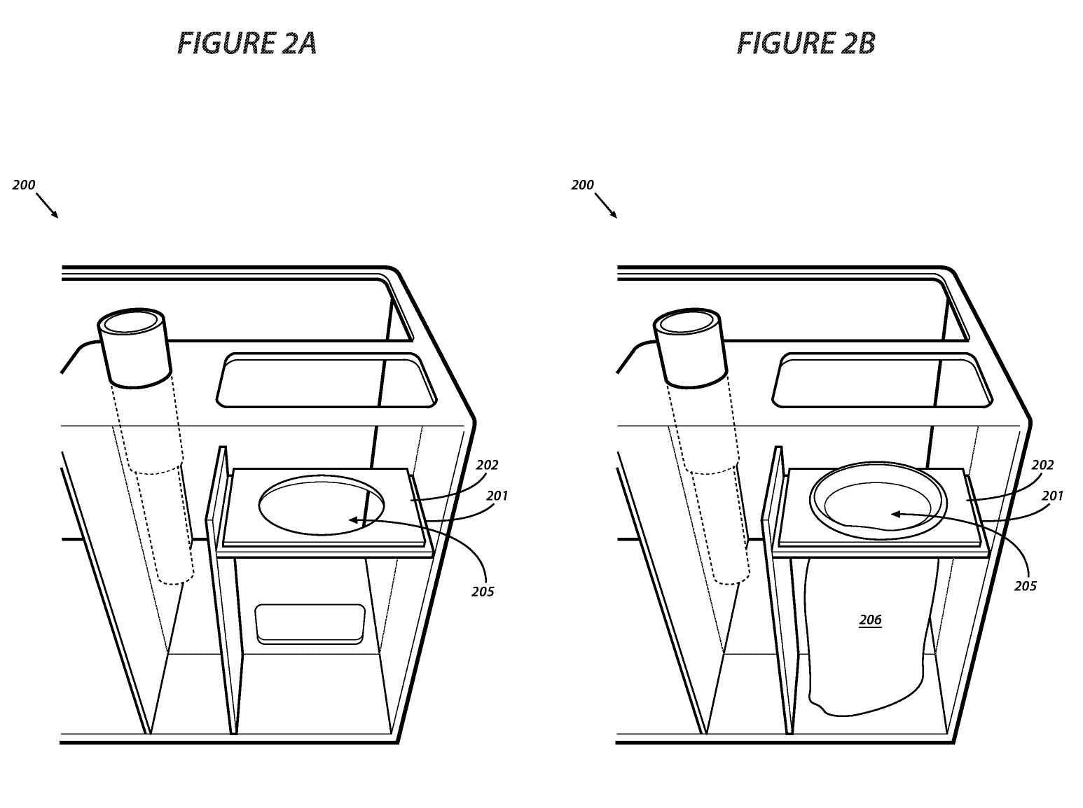

FIG. 2A is a partial illustration of a sump unit 200 with a filter sock plate 202 installed therein. A filter sock plate 202 is stationed upon filter plate holder 201. A filter sock may be installed such that it is disposed through the cavity of the filter sock plate 202 and the filter plate holder 201.

FIG. 2B is a partial illustration of a sump unit 200 with a filter sock plate 202 and filter sock 206 installed therein. Filter sock plate 202 is stationed upon filter plate holder 201 which allows the filter sock 206 to suspend through the opening 205 of the filter plate holder 201 and the filter sock plate 202.

One having ordinary skill in the art may appreciate that a filter sock 206 may be embodied as a tube-sock mesh or felt that catches particulates (e.g., typically in hundreds of microns) to prevent contamination sources to the aquarium water. Filter socks 206 are typically cleaned and changed out every few days to prevent the filter sock from being a source of contamination.

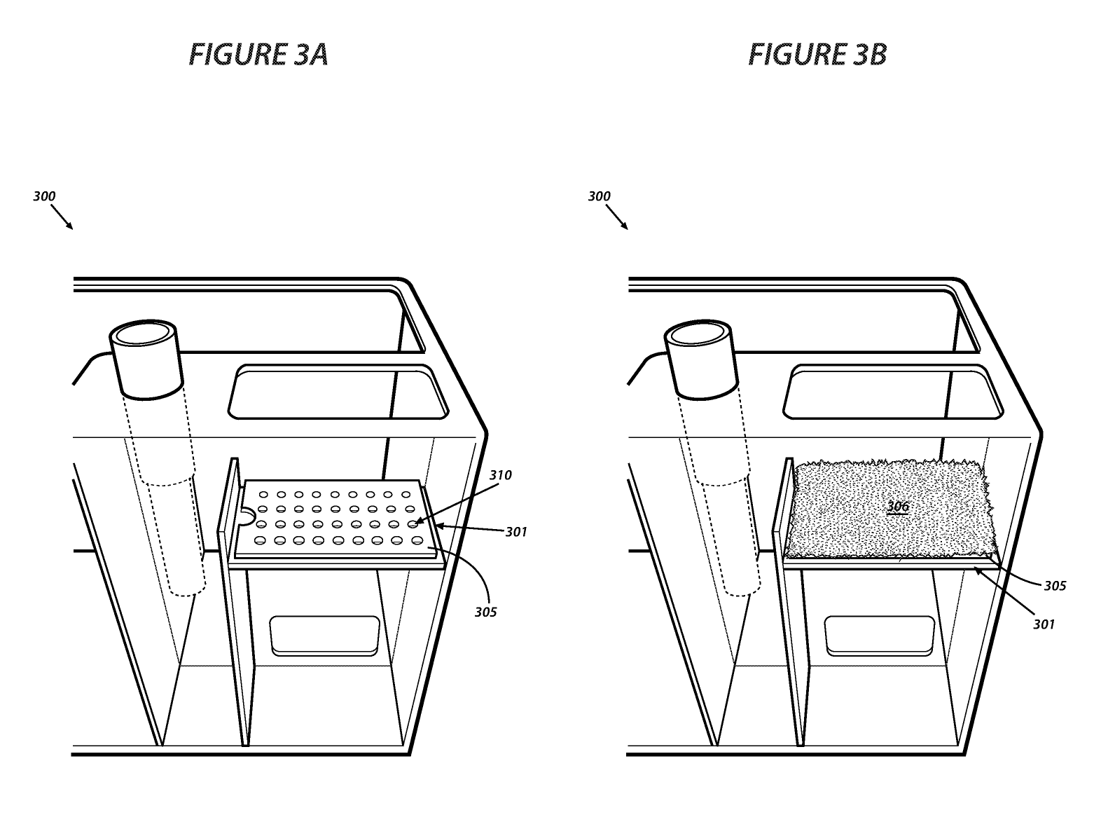

FIG. 3A is a partial illustration of a sump unit 300 with a perforated plate 305 installed therein. Perforated plate 305 has a plurality of cavities 310 which aid in spreading the aquarium water across the plate's 305 area. A foam block may be installed over the perforated plate 305 as shown in FIG. 3B.

FIG. 3B is a partial illustration of a sump unit 300 within an aquarium tank with a perforated plate 305 and a foam block 306 installed therein. Foam block 306 is stationed upon the perforated plate 305 whereas the plate 305 is stationed upon the filter plate holder 301. In some implementations, foam block 306 is utilized to collect particulate matter. Foam block 306 may be made of a coarse material to trap food, plant fragments, waste, debris, and other matter within the aquarium water. Sump unit 300 may facilitate various filtration configurations according to an end user's filtration objectives.

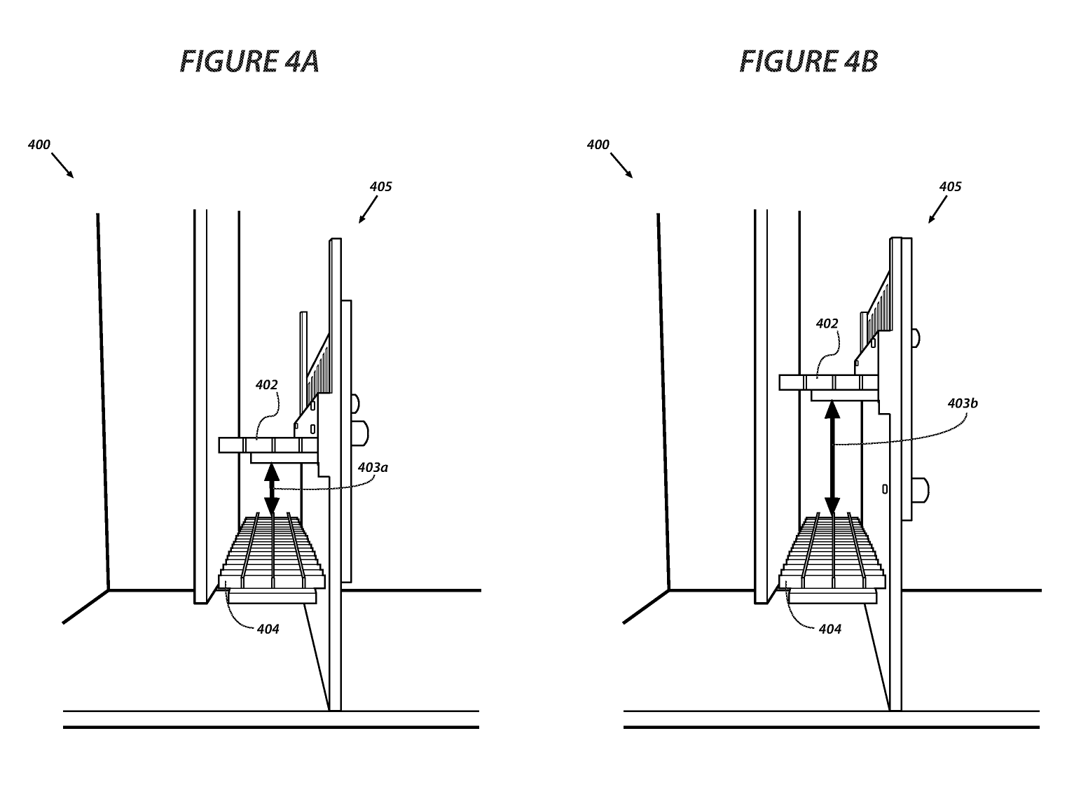

FIG. 4A is an exemplary illustration of a self-adjusting media tray apparatus 405 of a sump unit. Self-adjusting media tray apparatus 405 comprises a top media tray 402 and a bottom media tray 404. Top media tray 402 may support a foam block, perforated plate, or similar apparatus whereas bottom media tray 404 may support media such as a bag of carbon.

In some implementations, top and bottom media trays 402, 404 may support mechanical filter media, biological filter media, or chemical filter media. Mechanical filter media may be used to physically trap and remove debris and particles from the aquarium water to keep the aquarium water clean, clear, and free of floating particles. In some implementations, mechanical filter media may also prevent particulate matter from clogging the biological media. Mechanical filter media may be available in different grades to remove particles of varying sizes (e.g., coarse media to trap large particles and fine media to trap very small particles).

Biological filter media may break down organic waste material into less harmful components. Chemical filter media may be used to remove pollutants and other unwanted materials through chemical reactions and when used properly may serve as a convenient way to maintain proper water quality for an extended period of time. Chemical filter media may also strengthen the filtering capacity of any filtration system by removing pollutants that mechanical and biological media may not be able to remove. In addition, chemical filtering may add supplements (e.g., to bring calcium and alkalinity levels higher which is more desirable for corals and algae growth) to the aquarium water.

The level of the aquarium water within the sump unit may be adjusted by the user. In some implementations, top media tray 402 may be moved up and down. In FIG. 4A, top media tray 402 is in a first position. In this first position, the aquarium water is at its lowest level. In some embodiments, top media tray 402 moves automatically due to the attachment to the attached wall as the water level is adjusted. Without this feature, the space 403a between the top and bottom media trays 402, 404 would stay the same.

FIG. 4B is a self-adjusting media tray apparatus having a self-adjusting media tray in a second position within a sump unit. The ability to adjust the vertical displacement of top media tray 402 from second media tray 404, and to set the tray 402 to a desired height, maximizes the space 403b for filter media to be stationed on the second media tray 404 which reduces the degree to which the aquarium water splashes and forms bubbles.

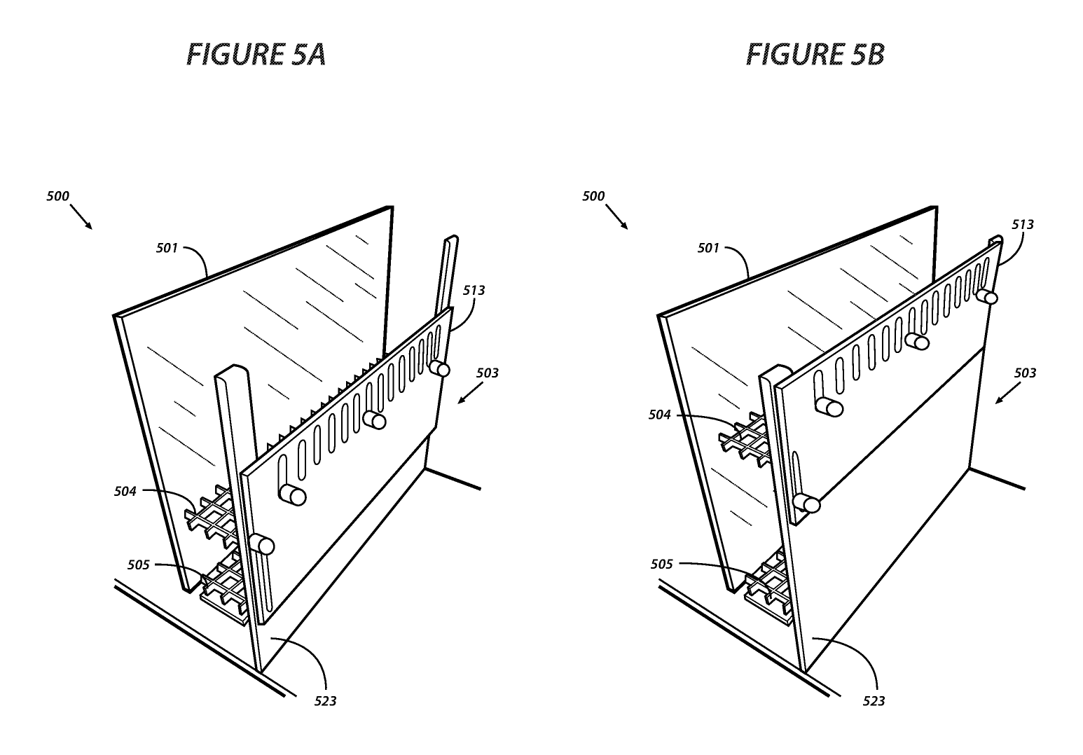

FIG. 5A is another illustration of a self-adjusting media tray 500 in a first position. Self-adjusting media tray 500 includes fixtures such as walls 501, 503 which may be attached to surfaces within the sump unit. In one embodiment, first media tray 504 and second media tray 505 extend from wall 503. A third and fourth wall (not shown) may be adjacent and perpendicular to the opposite ends of the first and second walls 501, 503. In another embodiment, first media tray 504 extends from the first wall 501 whereas the second media tray 505 extends from side walls within the sump unit.

Wall 503 may include a base portion 523 and a height-adjustable component 513 that is slidably coupled thereto. As such, wall 503 allows the first media tray 504 to assume various vertical positions (e.g., first and second positions). In the embodiment shown in FIG. 5A, first media tray 504 is in the first position and is closer to the second media tray 505 than in FIG. 5B.

FIG. 5B depicts another illustration of the self-adjusting media tray 500 in a second position. It may be advantageous to move the first media tray 504 to accommodate filtering media that require additional space.

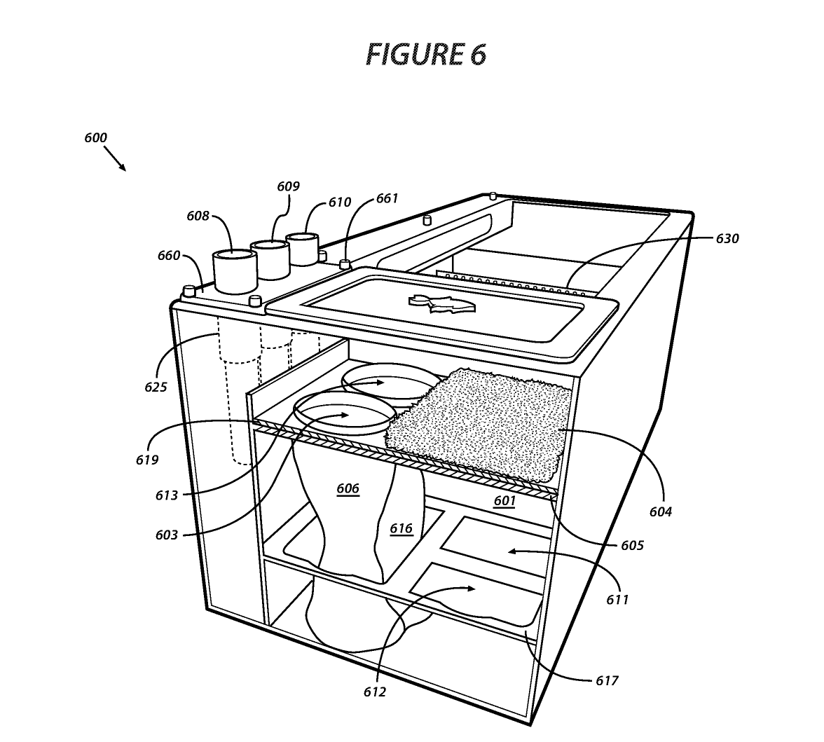

FIG. 6 is yet another illustration of a sump unit 600 which features a first filtering configuration. Within sump area 601, a plurality of filtering devices may be disposed therein. For example, filter socks 606, 616 may be secured in individual or shared compartments. Furthermore, the filtering configuration shown may also utilize a filter plate holder 605 (with a plate 619 thereon) upon which a foam block 604 or other filtering device rests thereon. During operation of the aquarium system, aquarium water flows into the sump unit 600 and into the filter socks 606, 616 (through openings 603, 613).

In other filtering configurations, foam block 604 may be replaced with filter socks. Likewise, filter socks 606, 616 may be substituted with one or more foam blocks. As such, one having ordinary skill in the art may appreciate that foam block 604 and filter socks 606, 616 may be replaced with other filtering devices known in the art.

In the figure, filter socks 606, 616 are primary filtering mechanisms since these filtering devices are nearest to the drain pipes 625. Likewise, because foam block 604 is further from the drain pipes 625 than filter socks 606, 616, foam block 604 may be considered a secondary filtering mechanism in this embodiment.

Once aquarium water enters the sump unit 600, the aquarium water eventually flow to the filter socks 606, 616. In the event that the filter socks 606, 616 clog or otherwise fail to function, the aquarium water may flow pass the openings 603, 613 of the filter socks 606, 616 to the foam block 604.

In some implementations, foam block 604 may provide mechanical filtration to remove solid particles from the aquarium water. Additionally, foam block 604 may function as a silencer to reduce the noise associated with the aquarium water as it flows into various filtering components.

Sump unit 600 also features an interchangeable drain input plate 660, which may be secured by nylon bolts 661, with different bulkhead fittings 608, 609, 610 to accommodate various aquarium designs. In the embodiment shown, bulkhead fittings 608, 609, 610 have a different size. For example, bulkhead fitting 608 has a 1″ threaded fitting, bulkhead fitting 609 has a 1.5″ threaded fitting, and bulkhead fitting 610 has a 2″ threaded fitting. Each bulkhead fitting may have the same size or may be different according to the configuration of the aquarium system. It should be noted that the present disclosure is not limited to an interchangeable drain input plate 660 with three bulkhead fittings. As such, interchangeable drain input plate 660 may have more or less than three bulkhead fittings according to choice and design.

In addition, sump unit 600 may include a lower plate holder 617 which may accommodate the fitting of flow plates, foam blocks, and biological filter media. For example, lower plate holder 617 may accommodate a plurality of tertiary filtering devices (e.g., such as foam or biological media in areas 611, 612). Advantageously, sump unit 600 may accommodate various filtering configurations.

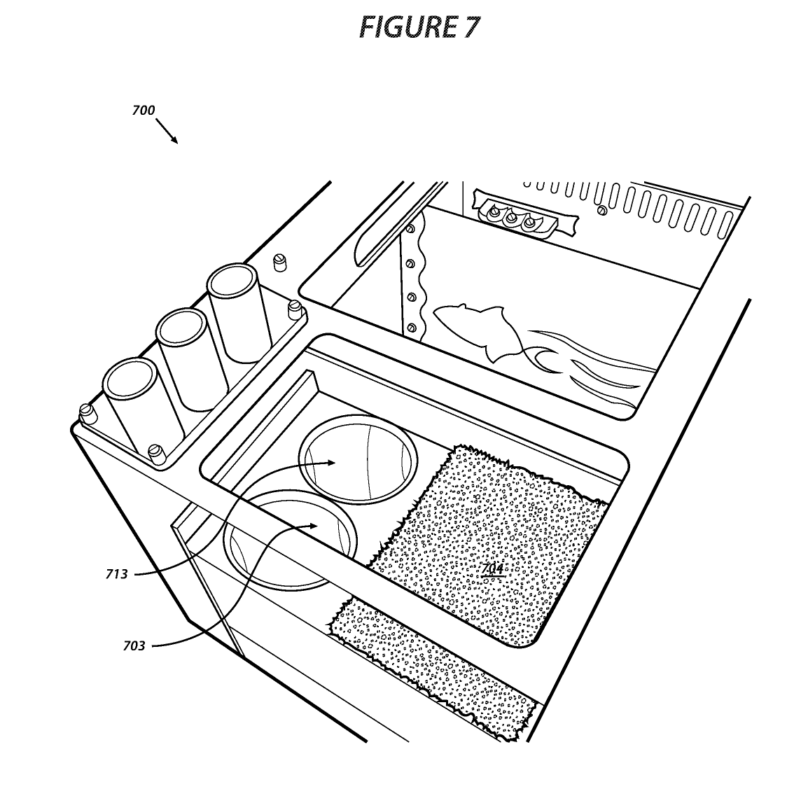

FIG. 7 is a top view of the sump unit 700 from FIG. 6. From this view, foam block 704 and openings 703, 713 of the filter socks are clearly shown. Sump unit 700 may be integrated within an aquarium system.

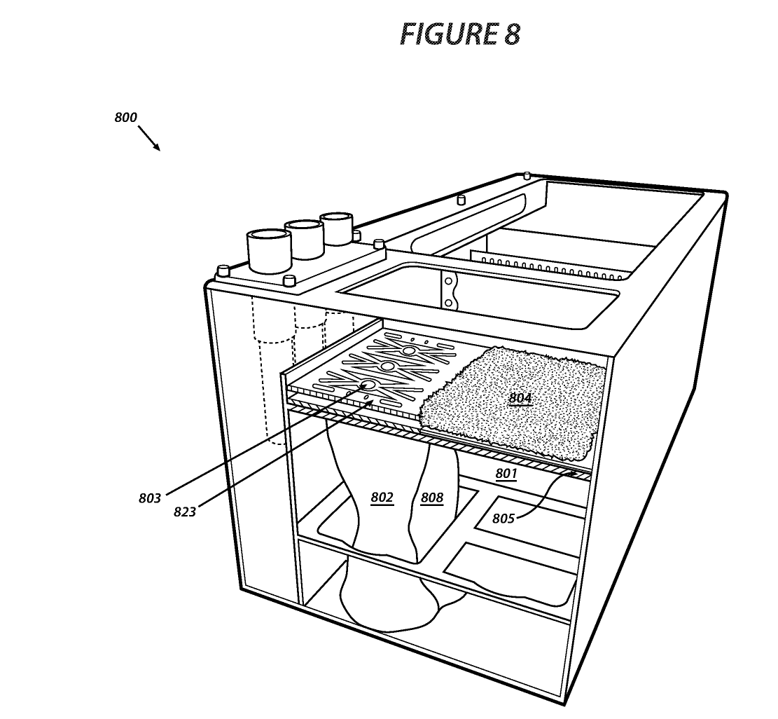

FIG. 8 is an exemplary illustration of a sump unit 800 which features a second filtering configuration in the sump area 801. In the second filtering configuration shown, sump unit 800 implements filter socks 802, 808, foam block 804, and flow plate 823. In some embodiments, flow plate 823 is a high-flow plate which features large cavities 803 to maximize the rate that the aquarium water flows upon the filtering device. Alternatively, flow plate 823 may be a low-flow plate in some embodiments which feature smaller cavities 803 to reduce the rate that the aquarium flows upon the filtering device.

As depicted, filter plate 823 has a plurality of openings 803 that are fashioned in a way to allow or inhibit the flow of aquarium water to the secondary or backup filtering mechanism (e.g. foam block 804). Advantageously, filter plate holder 805 accommodates various filtering devices which have varying dimensions and utility.

In some embodiments, filter socks 802, 808 with flow plate 823 stationed thereon may be implemented as a primary filtering mechanism since the aquarium water reaches these filtering devices upon entering the sump unit 800. However, flow plate 823 may be designed such that some of the aquarium water reaches the foam block 804. For example, the size, shape, number, and placement of the cavities 803 within flow plate 823 may determine the amount of aquarium water that reaches foam block 804. Other plates, such as the one shown in FIG. 3A, may be used to allow more aquarium water to reach the foam block 804. As such, foam block 804 may be implemented as a secondary or backup filtering mechanism in the second filtering configuration.

It should be understood by one having ordinary skill in the art that the amount of aquarium water that reaches foam block 804 may also depend on the flow rate that the aquarium water travels throughout the aquarium system. By way of example, it would be expected that more aquarium water reaches the secondary or backup filtering mechanism foam block 804 for a flow rate of 2,000 gallons/hour than a flow rate of 500 gallons/hour.

Flow plate 823 may further reduce the noise associated with the aquarium water flowing into the filter socks 802, 808. In some implementations, foam block 804 functions as a silencer as well.

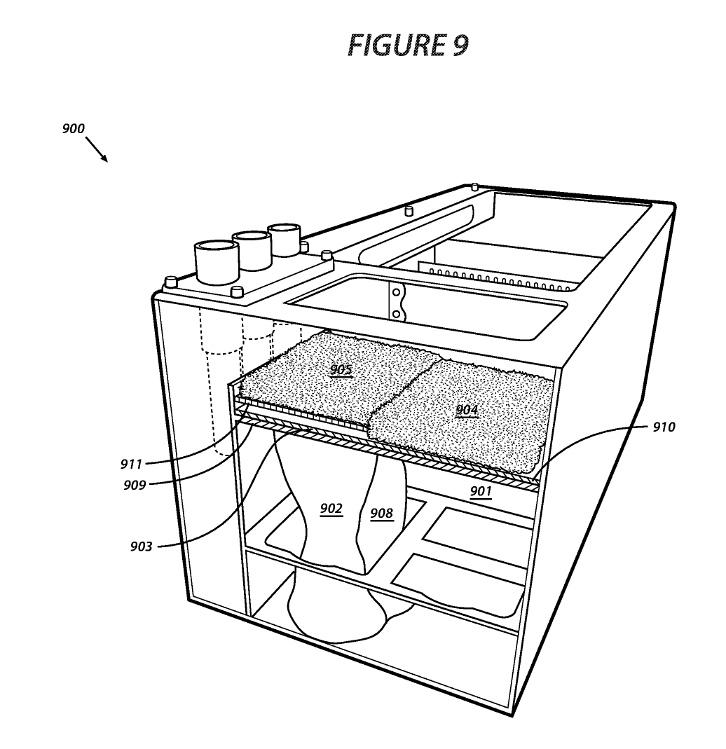

FIG. 9 is another exemplary illustration of a sump unit 900 which features a third filtering configuration within the sump area 901. In the figure shown, sump unit 900 has primarily and backup filtering mechanisms. The primary filtering mechanism comprises filter sock plate 903, filter socks 902, 908, foam block 905, and flow plate 911 which are all supported by filter plate holder 909. The backup filtering mechanism comprises a foam block 904 that is supported by flow plate 910 and filter plate holder 909.

Both foam blocks 904, 905 provide mechanical filtration to screen solid particles from the aquarium water. In one implementation, foam block 904 and foam block 905 have different coarseness characteristics and thicknesses to allow for different mechanical filtration and water flow effects. For example, foam block 904 may have a coarseness of 20 parts per inch (PPI) and a thickness of approximately 0.375″ whereas foam block 905 may have a coarseness of 10 PPI and a thickness of approximately 0.75″.

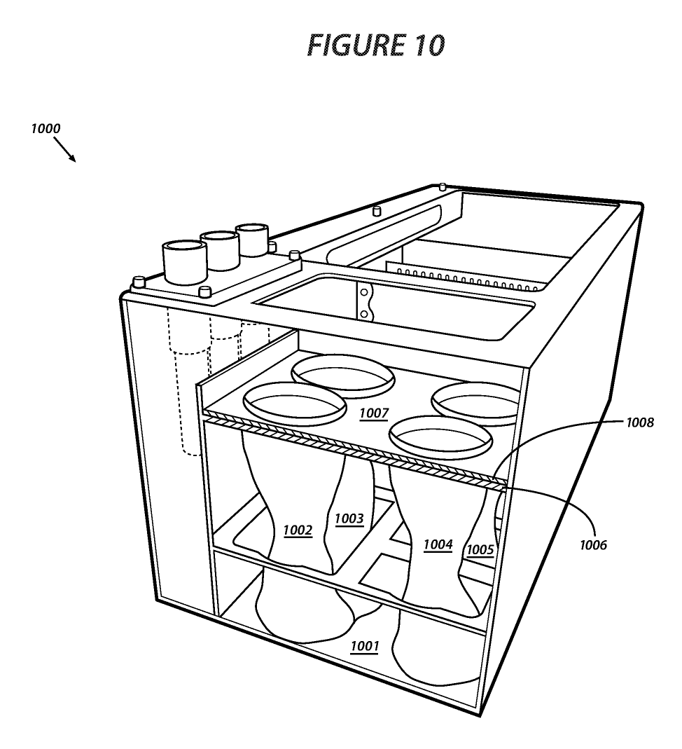

FIG. 10 is an exemplary illustration of a sump unit 1000 which features a fourth filtering configuration within the sump area 1001. As shown, a filter plate holder 1006 supports a filter sock plate 1008 that holds four filter socks 1002, 1003, 1004, 1005. Filter socks 1002, 1003 may be implemented as a primary filtering mechanism whereas filter socks 1004, 1005 may be implemented as a back-up filtering mechanism.

The filter socks 1002, 1003, 1004, 1005 may have different pore sizes. For example filter socks 1002, 1003 may have pore sizes that are approximately 200 microns whereas the pore sizes of filter socks 1004, 1005 may be approximately 100 microns. One having ordinary skill in the art will appreciate that the differences in pores sizes may affect the size and the amount of particulate that can be filtered by the socks. In addition, the pore sizes may also affect the life cycle of the filter socks. For example, a filter sock with a significantly greater pore size may last longer than a filter sock with a smaller pore size as the filter sock with the smaller pores is likely to get clogged before the filter sock with the larger pores.

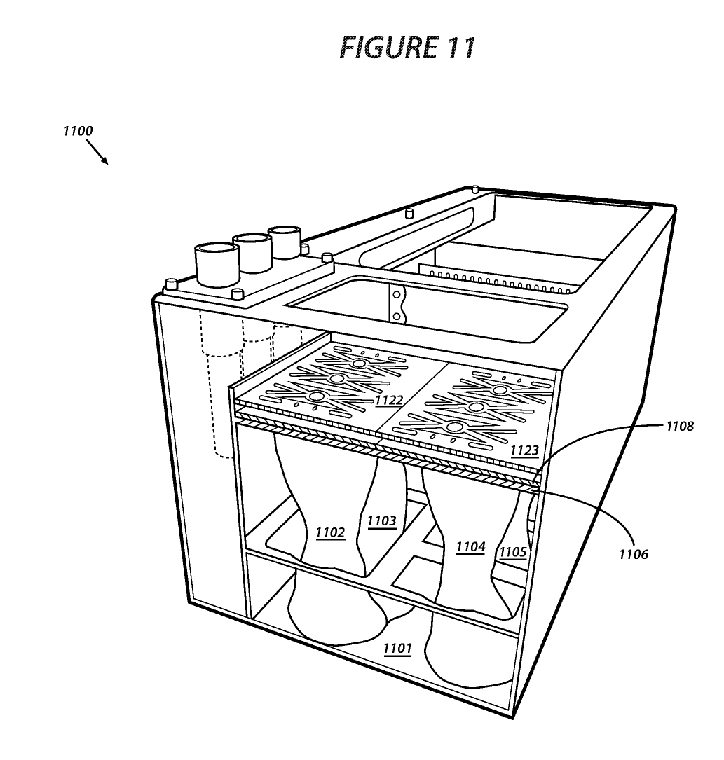

FIG. 11 is an exemplary illustration of a sump unit 1100 which features a fifth filtering configuration within the sump area 1101. Sump unit 1100 has a filter plate holder 1106 which supports four filter socks 1102, 1103, 1104, 1105 in a sock plate 1108. In addition, filter plate holder 1106 supports flow plates 1122, 1123.

In the embodiment shown, filter socks 1102, 1103 and flow plate 1122 are implemented as a primary filtering mechanism whereas filter socks 1104, 1105 and flow plate 1123 are implemented as a back-up filtering mechanism. The amount of aquarium water that reaches the second set of filtering devices may be determined by the design of flow plate 1122, 1123, the filter sock micron rating, and the flow rate of the aquarium water.

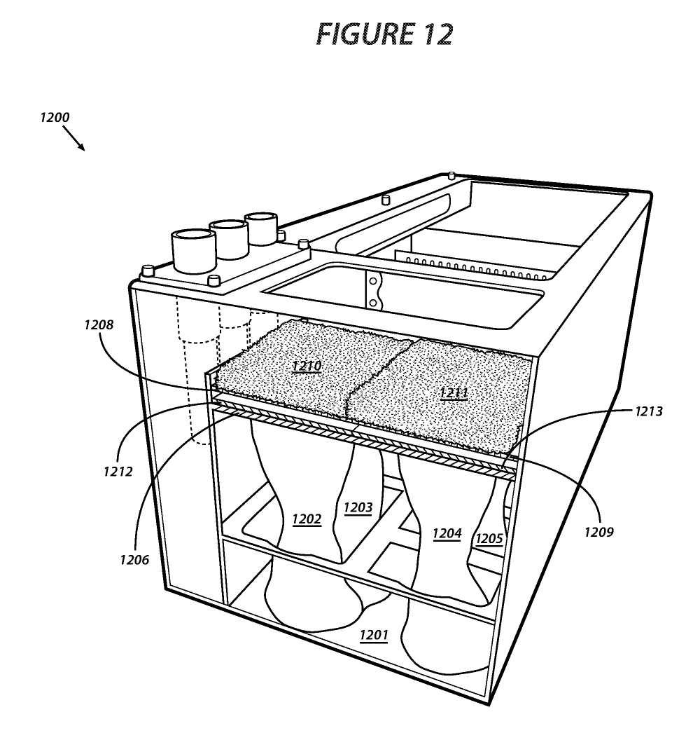

FIG. 12 is an exemplary illustration of a sump unit 1200 which features a sixth filtering configuration within the sump area 1201. Within sump unit 1201 are four filter socks 1202, 1203, 1204, 1205 held in place by filter sock plates 1212, 1213 which are supported by filter plate holder 1206. Stacked upon flow plates 1208, 1209 are foam blocks 1210, 1211 which employ both primary and secondary/back-up filtering mechanisms. Although foam blocks 1210, 1211 appear to be the same in the figure, the foam blocks 1210, 1211 may be different. As such, foam blocks 1210, 1211 may have a different coarseness or thickness profile. The combination of filtering devices may accomplish silencing, mechanical filtering, and secondary and back-up filtering mechanisms.

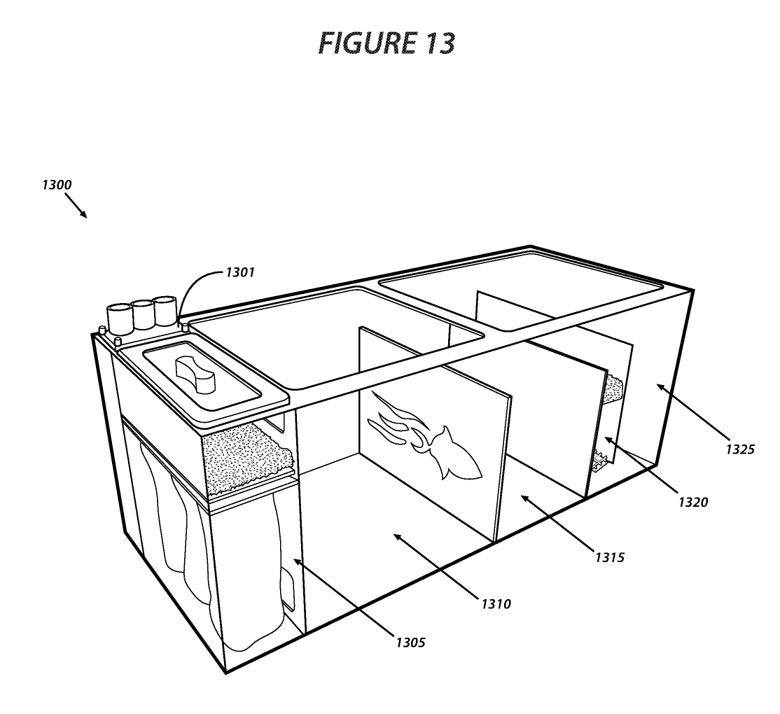

FIG. 13 is a perspective illustration of a novel sump unit 1300. Sump tank 1300 features several regions through which aquarium water flows throughout the sump unit 1300. Sump unit 1300 includes a filter region 1305, skimmer region 1310, refugium region 1315, self-adjusting media tray 1320, and return section 1325. Additionally, sump unit 1300 includes an interchangeable drain input plate 1301 which accommodates various bulkhead fitting sizes.

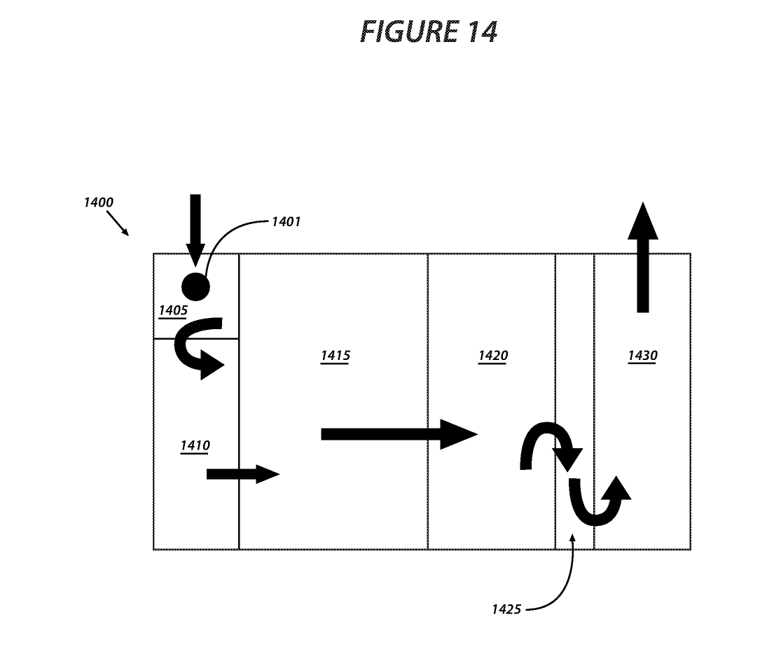

FIG. 14 is an illustration of a route that aquarium water travels through a sump filtration system 1400 consistent with the present disclosure. Aquarium water is routed to the sump unit 1400 through the bulkhead fittings 1401 which is attached to the drain input plate region 1405. As shown by the arrows, the aquarium water travels from the drain input plate region 1405 to an interchangeable plate region 1410 where it reaches at least one filtering mechanism (e.g., such as one or more filter socks within the interchangeable plate region 1410). The aquarium water then travels to skimmer region 1415 and into the refugium region 1420. The aquarium water then travels to the self-adjusting media tray area 1425 and to the return (pump) section 1430 where the aquarium water is routed back to an aquarium display tank (not shown in this figure).

This disclosure pertains to aquarium systems, and in particular (but not exclusively) to a novel sump filtration system for aquarium tanks. It will be understood by those having ordinary skill in the art that the present disclosure may be embodied in other specific forms without departing from the spirit and scope of the disclosure disclosed. In the examples and embodiments described herein are in all respects illustrative and not restrictive. Those skilled in the art of the present disclosure will recognize that other embodiments using the concepts described herein are also possible.

1. A sump filtration system, comprising:
a first wall; and
a second wall opposing the first wall,
wherein the second wall has a first media tray at a top portion and a second media tray at a bottom portion,
wherein the first wall is fixed to a surface and the second wall is moveable in a vertical direction.

2. The sump filtration system of claim 1, wherein the top portion of the second wall sets a water level.

3. The sump filtration system of claim 1 further comprising a third wall and a fourth wall adjacent and perpendicular to opposite ends of the first and second walls.

4. The sump filtration system of claim 1, wherein the bottom portion is fixed to the surface and the top portion is moveable in the vertical direction.

5. An aquarium system, comprising:
a display tank; and
a sump unit coupled to the display tank, the sump unit comprising:
a first wall; and
a second wall opposing the first wall,
wherein the second wall has a first media tray at a top portion and a second media tray at a bottom portion,
wherein the first wall is fixed to a surface and the second wall is moveable in a vertical direction.

6. The aquarium system of claim 5, wherein when the first wall is in a first position, the first media tray is disposed a first distance from the second media tray,
wherein when the first wall is in a second position, the first media tray is disposed a second distance from the second media tray,
wherein the second distance is greater than the first distance.

7. The aquarium system of claim 5 further comprising a foam block disposed on the first media tray.

8. The aquarium system of claim 5, wherein the second wall has a first portion that is fixed to a surface and a second portion that is moveable in a vertical direction.

9. The aquarium system of claim 5 further comprising an interchangeable drain input plate mounted onto a top support brace of the sump unit wherein the interchangeable drain input plate has at least one bulkhead fitting.

10. The aquarium system of claim 9, wherein the interchangeable drain input plate comprises a plurality of bulkhead fittings.

11. The aquarium system of claim 5, wherein a plumbing component couples the sump unit to the display tank.

12. The aquarium system of claim 5 further comprising a bag of carbon on the surface of the second media tray.

13. A sump filtration system, comprising:
an enclosed compartment, comprising:
a top plate holder to support a plurality of filter configurations; and
a lower plate holder to support a plurality of tertiary filter devices.

14. The sump filtration system of claim 13, wherein the top plate holder can support a filter sock.

15. The sump filtration system of claim 13, wherein the top plate holder can support a perforated plate.

16. The sump filtration system of claim 13, wherein the top plate holder can support a plurality of primary filtering devices and a plurality of back-up filtering devices.

17. The sump filtration system of claim 16, wherein the plurality of primary filtering devices comprises at least one filter sock and the back-up filtering mechanism comprises at least one foam block.

18. The sump filtration system of claim 17, wherein the top plate holder supports a flow plate stationed upon a filter sock.

19. The sump filtration system of claim 18, wherein the top plate holder supports at least two perforated plates.

20. The sump filtration system of claim 13, wherein the top plate holder supports a filter sock, a perforated plate stationed upon the filter sock, and a foam block stationed upon the perforated plate.
